(19) United States
(12) Patent Application Publication
(10) Pub. No.: US 2013/0227118 A1
(43) Pub. Date: Aug. 29, 2013

(54) SYSTEM AND METHOD FOR PROVIDING ACCESS TO PRESENCE STATUS FOR MOBILE DEVICES

(71) Applicants: Silviu Florian SIMEN, Mississauga (CA); Leif Edvard BILDOY, Isleworth (GB); Tao CUI, San Jose, CA (US); Donald Scott CLAYTON, Toronto (CA); Alina KUSHNIR, Vaughan (CA); Wayne David RANTALA, Kanata (CA)

(72) Inventors: Silviu Florian SIMEN, Mississauga (CA); Leif Edvard BILDOY, Isleworth (GB); Tao CUI, San Jose, CA (US); Donald Scott CLAYTON, Toronto (CA); Alina KUSHNIR, Vaughan (CA); Wayne David RANTALA, Kanata (CA)

(73) Assignee: RESEARCH IN MOTION LIMITED, Waterloo (CA)

(21) Appl. No.: 13/408,891

(22) Filed: Feb. 29, 2012

(51) Int. Cl. G06F 15/173

(52) U.S. Cl. 709/224

(57) ABSTRACT

A system and method are provided for enabling access to presence status for mobile devices. The method comprises receiving, via an application programming interface, an application inquiry, the application inquiry requesting a presence data for at least one mobile device; responsive to receiving said inquiry, obtaining network data from one or more network infrastructure nodes associated with providing service to the at least one mobile device; determining a response to the application inquiry based upon the network data; and providing the response via the application programming interface.

### TECHNICAL FIELD

The following relates to systems and methods for providing access to presence status for mobile devices.

### DESCRIPTION OF THE RELATED ART

Applications developed for mobile devices may depend on, or otherwise utilize, device presence information about particular devices. For example, a server may also wish to send data to a mobile device based on presence information, for example, only when that mobile device is in coverage. A mobile device may also wish to know the coverage status of another device. Currently, client side applications may be relied upon to report device presence information to a server associated with the particular client application. However, relying on the client application to determine device presence information and provide this information to the server can be inefficient and/or require complex low-level programming on the part of the application developer.

### BRIEF DESCRIPTION OF THE DRAWINGS

Embodiments will now be described by way of example only with reference to the appended drawings wherein:

FIG. 1 is a schematic diagram of a communication system having a network infrastructure;

FIG. 2 is a schematic diagram of a communication system having a network infrastructure;

FIG. 3 is a schematic diagram of a communication system having a network infrastructure;

FIG. 4 is a block diagram of an example of a configuration for a device presence proxy;

FIG. 5 is a block diagram of an example of a configuration for an application server;

FIG. 6 is a block diagram of an example of a configuration for a mobile device;

FIG. 7 is a flow chart illustrating an example of a set of computer executable operations that may be performed in obtaining device presence information determined from a network infrastructure;

FIG. 8 is a schematic diagram of a communication system having a network infrastructure including multiple infrastructure nodes;

FIG. 9 is a sequence diagram illustrating operations performed in obtaining presence information; and

FIG. 10 is a sequence diagram illustrating operations performed in determining presence information using network data.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It has been found that allowing application developers to use network- or cloud-based resources and application programming interfaces (APIs) enables rapid deployment of applications. By providing an API front-end in an application development platform that exposes data from a proxy or other entity having access to data in a network infrastructure, applications and application servers can query and receive device presence information for a particular device, the presence information being mined from the network infrastructure. The API exposes information available to the device presence proxy, deployed in, or otherwise in communication with, the network infrastructure, to enable the applications and application servers to obtain device presence information mined from the network infrastructure.

The device presence proxy, the application server, or both the device presence proxy and application server may be hosted by a cloud-based platform to enable applications and application servers to be developed using the cloud-based platform with such application servers hosted in the cloud. In this way, rapid application development can be supported by reducing the low-level programming required to obtain network presence information concerning one or more mobile devices.

The device presence information mined from the network infrastructure may include coverage status, roaming status, transport type, date of a previous transport change, time of a previous transport change, last authentication result for the mobile device, last time of authentication, etc.

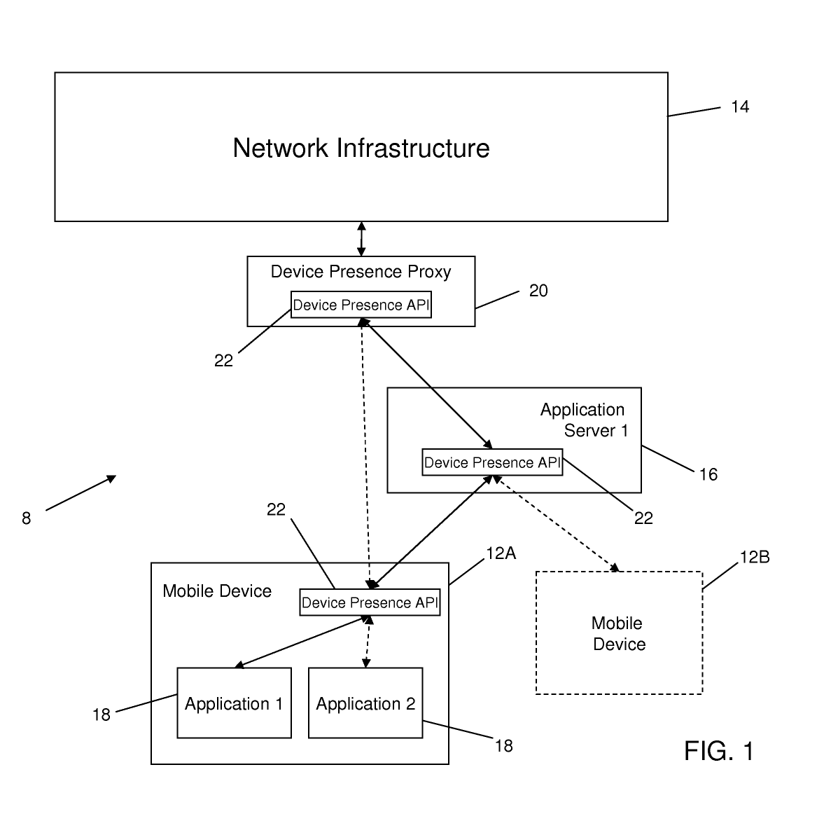

Referring now to FIG. 1, an example of a communication system 8 is shown, in which a mobile device (e.g., 12A and 12B, each of which may be referred to generically in this disclosure as mobile device 12) can communicate with or otherwise access a network infrastructure 14 for utilizing one or more network services, e.g., messaging, telephony, web access, etc. The mobile device 12A includes an application 18 that may operate with an associated application server 16. The application server 16 may be hosted by any suitable network- or cloud-based system, or may be custom built and hosted by a particular entity. In the example shown in FIG. 1, Application Server 1 is associated with a client application, such as Application 1. Application Server 1 may be communicable with client applications installed on more than one mobile device, e.g., Mobile Device 12A and Mobile Device 12B. For example, the application server 16 may be associated with copies of the application 18 on multiple mobile devices 12 A, 12B. As will be described, in one embodiment of the present disclosure Application Server 1 may utilize a single query to the device presence proxy 20 to obtain device presence information for a plurality of mobile devices. Also shown in FIG. 1 is an Application 2, which does not have a corresponding application server 16. The application server 16 is operable to communicate with a device presence proxy 20 by having access to a device presence API 22. The device presence proxy 20 is included in or otherwise in communication with the network infrastructure 14 for obtaining device presence information and exposing that device presence information via the device presence API 22 made available to the application server 16. In some implementations, the mobile device 12A may also include a device presence API 22 for communicating with the application server 16 in obtaining device presence information exposed by the device presence proxy 20.

As noted above, some applications 18 may not have a corresponding application server 16 and thus the device presence API 22 may also provide programming instructions to enable particular applications 18 (e.g., Application 2) to communicate directly with the device presence API 22 in the device presence proxy 20 in order to obtain network data exposed by the device presence proxy 20 directly as illustrated in dashed lines in FIG. 1. It can be appreciated that the device presence API 22 is shown using a common reference numeral for the sake of illustration and that this API may differ depending on which device contains it. For example, instructions included in the device presence API 22 on the mobile device 12 may differ from those included in an application server 16.

The configuration shown in FIG. 1 enables applications 18 and application servers 16 to determine a device's network-related presence without having to query the mobile device 12 or rely on reports from the mobile device 12. Exposing data provided by the network infrastructure 14 can minimize the low-level programming required by the application developer to obtain presence information for a particular mobile device 12 that is required or otherwise utilized by an application client 18 and/or application server 16. Moreover, applications 18 deployed on the mobile device 12 do not need to have knowledge of the particular device type, OS version or memory location in order to determine network-based device presence since the device presence API 22 provides a network- or cloud-based source for such information.

The device presence proxy 20 may be hosted on or otherwise provided by a server apparatus or network component having a processor or processing capabilities. Although the device presence proxy 20 shown in FIG. 1 is part of the network infrastructure 14, it can be appreciated that the device presence proxy 20 may instead be independent of and communicable with the network infrastructure 14.

The device presence proxy 20 has access to, for example, network infrastructure nodes in the network infrastructure 14 that can determine various device presence status types based on interactions between the mobile device 12 and the network infrastructure 14, e.g., where the network infrastructure nodes are associated with providing network services to the mobile device 12. The device presence information mined from the network infrastructure 14 may include coverage status, roaming status, transport type, date of a previous transport change, time of a previous transport change, last authentication result for the mobile device, last time of authentication, etc.

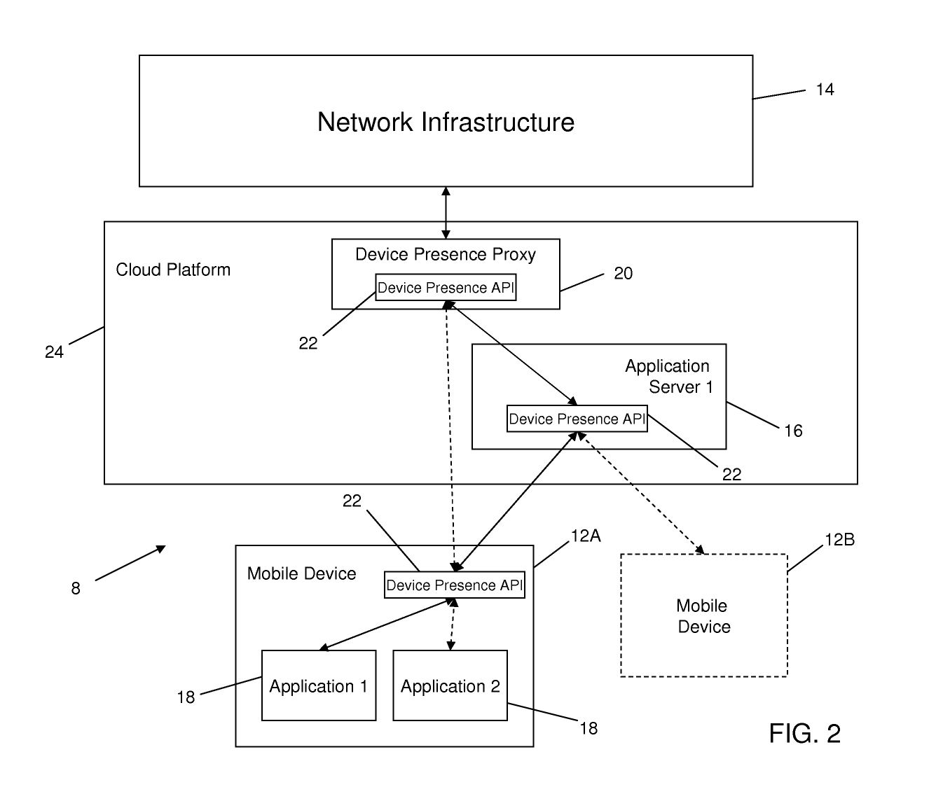

As illustrated in FIG. 2, the device presence proxy 20 and the application server 16 may be hosted or otherwise provided by a cloud-based application development platform (cloud platform 24 hereinafter). The cloud platform 24 provides a central resource for applications that are deployed on to mobile devices 12. For example, the cloud platform 24 may be accessed by a developer to obtain a programming toolkit for developing an application 18 that can be deployed to various mobile device 12, and for hosting an application server 16 corresponding to the application 18.

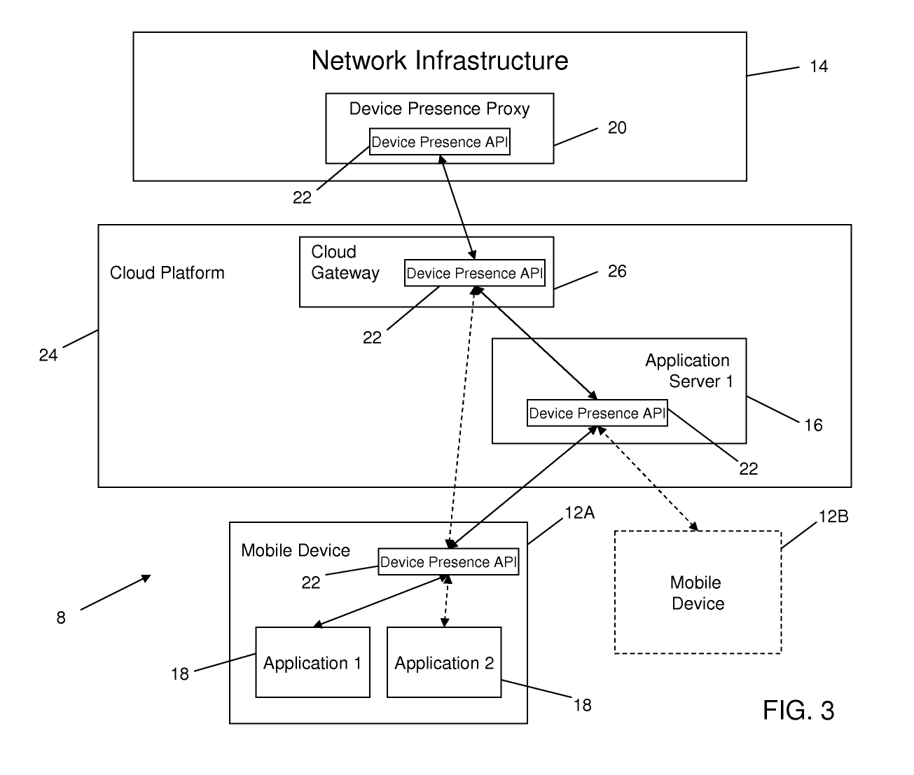

It can be appreciated that the cloud platform 24 may be part of a wider cloud-based environment that provides other services. For example, as shown in FIG. 3, the cloud platform 24 may include a cloud gateway 26 that provides an access point for interfacing with the network infrastructure 14. As discussed below, the cloud gateway 26 may be used to query domains within the network infrastructure 14 that are different from those relied upon for mining device presence information. For example, the cloud gateway 26 may also be used to obtain device billing information by accessing a provisioning server. In the configuration shown in FIG. 3, the cloud gateway 26 includes the device presence API 22 for communicating with the device presence proxy 20 which, in FIG. 3 is in the network infrastructure 14. The cloud gateway 26 may be responsible for managing queries to the network infrastructure 14 and thus may be used to authenticate and authorize requests, perform throttling and filtering, and to route requests to appropriate data providers (e.g., to specific domains and/or nodes within the network infrastructure 14). The cloud gateway 26 may therefore be an existing cloud platform component that is provided the device presence API 22 in order to enable device presence requests to be authorized and routed to the device presence proxy 20, among other requests.

It can be appreciated that depending on the role of the cloud gateway 26, the device presence API 22 provided to the cloud gateway 26 may differ from the device presence API 22 made available to the mobile devices 12 and application servers 16. For example, the mobile devices 12 and application servers 16 may have an API that includes program instructions for communicating with the cloud gateway 26 rather than directly with the device presence proxy 20 in a “two-tiered” configuration. For the purpose of illustration, the device presence API 22 will be considered any API that provides the ability to obtain device presence information, whether directly from the device presence proxy 20 (e.g., as shown in FIGS. 1 and 2), or via another agent or service or entity such as the cloud gateway 26 shown in FIG. 3.

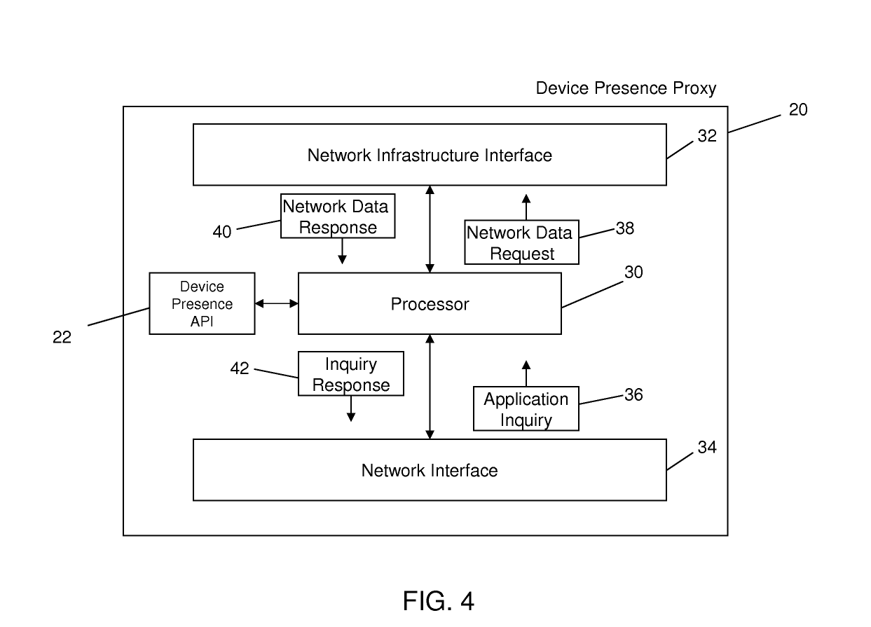

FIG. 4 illustrates an example of a configuration for the device presence proxy 20. The device presence proxy 20 includes a processor 30 for processing application inquiries 36 from applications 18 and/or application servers 16 requesting presence data for at least one mobile device 12; and for obtaining network data from, for example, network infrastructure nodes associated with network services provided to the mobile device 12, in order to respond to the application inquires 36. The application inquiries 36 and inquiry responses 42 may be formatted according to message syntax associated with the the device presence API 22. The device presence proxy 20 includes a network infrastructure interface 32 for communicating with the network infrastructure 14 in order to, for example, participate in a request-response exchange with one or more network infrastructure nodes. It can be appreciated that the network infrastructure interface 32 generally represents any software, hardware, or combination thereof, used or required to connect and communicate with the network infrastructure 14. The device presence proxy 20 also includes a network interface 34 for communicating via one or more networks within the communication system 8 (e.g., via the Internet, a cellular network, etc.). The device presence proxy 20 may also communicate with one or more of the cloud gateway 26 (FIG. 3) in the cloud platform 24, application servers 16 (FIGS. 1-3), and mobile devices 12 (FIGS. 1-3). The device presence API 22 provided to the cloud gateway 26 and/or application servers 16 and/or mobile devices 12, enables the application 18 and/or application server 16 to obtain data exposed by the network infrastructure 14. It can be appreciated that the network interface 34 generally represents any software, hardware, or combination thereof, used or required to connect and communicate with the cloud gateway 26, application server 16 and mobile device 12.

The processor 30 receives an application inquiry 36 from the cloud gateway 26, mobile device 12, or application server 16 via the network interface 34, the application inquiry 36 requesting a presence data for at least one mobile device 12. Based on the application inquiry 36, the processor 30 sends a network data request 38 to the network infrastructure 14 via the network infrastructure interface 32, to obtain network data from one or more network infrastructure nodes associated with providing service to the at least one mobile device 12. The processor 30 receives or otherwise obtains a network data response 40 from the network infrastructure 14, which includes the requested network data. The processor 30 then uses the obtained network data to determine an application inquiry response 42 to the application inquiry 36 and sends the inquiry response 42 to the requestor, e.g., the cloud gateway 26, mobile device 12, or application server 16, depending on from where the application inquiry 36 originated, via the network interface 34.

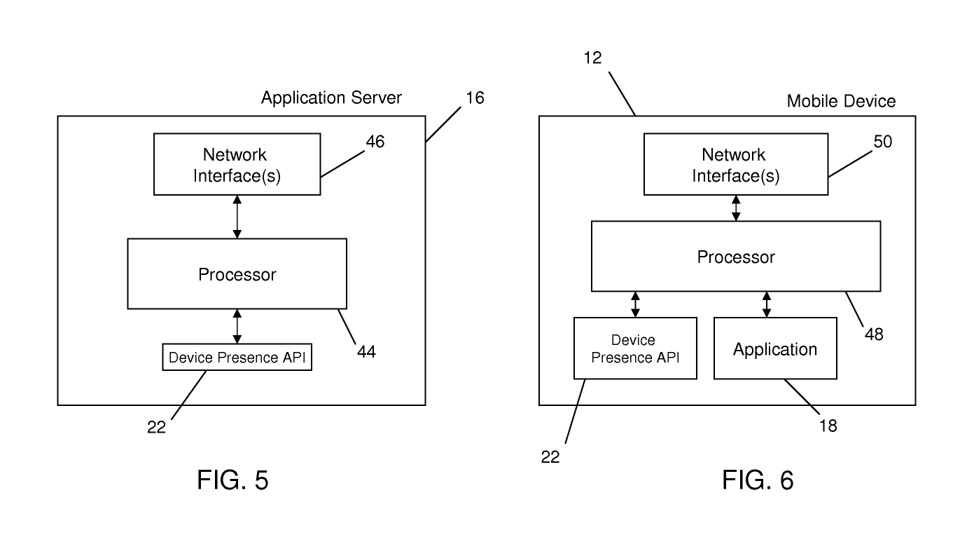

FIG. 5 illustrates an example of a configuration for the application server 16. It can be appreciated that various components of the application server 16 are omitted for brevity. The application server 16 includes one or more network interfaces 46 for communicating with one or more mobile devices 12 and for communicating with the cloud gateway 26 or device presence proxy 20 using the device presence API 22. The application server 16 also includes a processor 44 for handling requests from mobile devices 12, providing responses to the mobile devices 12, and for exchange request and responses with the cloud gateway 26 or device presence proxy 20, among other things.

The mobile device 12 also includes one or more network interfaces 50 for accessing and utilizing the network services and for enabling the application 18 to communicate with the application server 16, device presence proxy 20 and/or cloud gateway 26. The mobile device 12 also includes a processor 48 for executing program instructions, e.g., for utilizing the device presence API 22, enabling the application 18 to be used, etc.

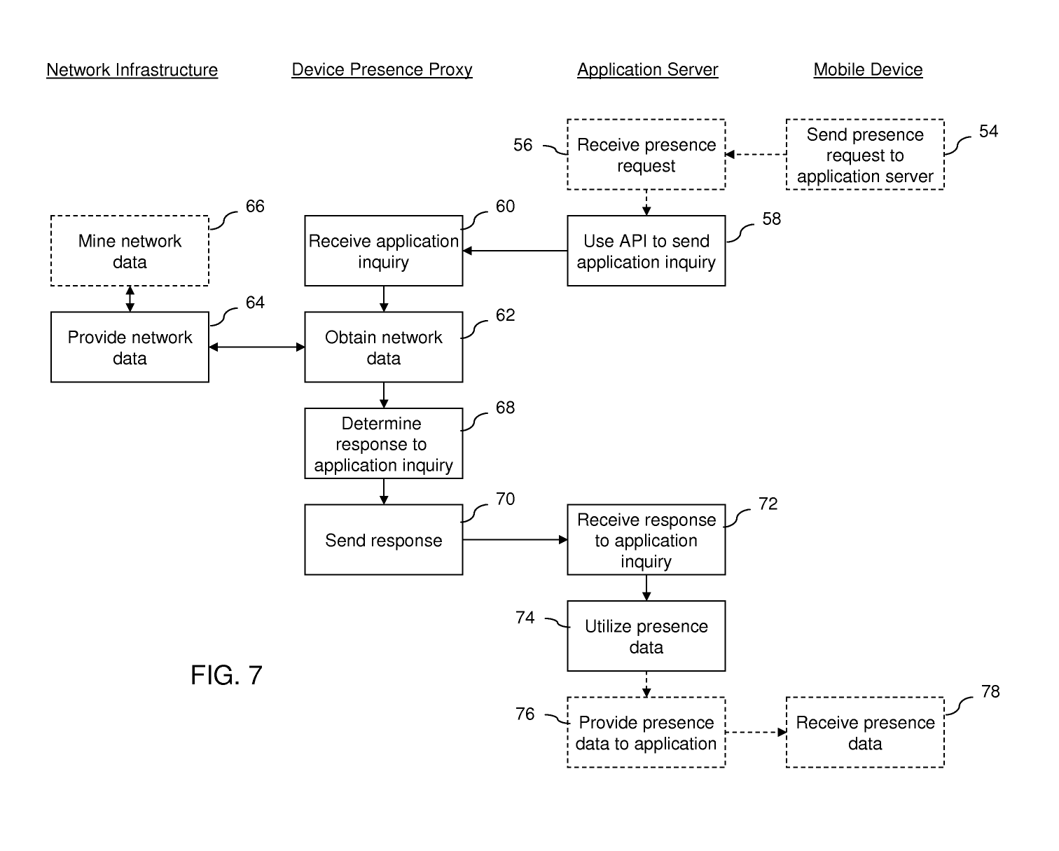

FIG. 7 illustrates several operations that may be performed by various components in obtaining device presence information from exposed data from the network infrastructure 14. The operations described in FIG. 7 represent processes that may be performed by each of the Network Infrastructure, Device Presence Proxy, Application Server, and Mobile Device. While they are shown together in FIG. 7, it should be understood that the process illustrated within each of the four columns may be independently described and claimed for each device. Furthermore, the operations described with regard to FIG. 7 may be embodied at each device using a variety of alternatives, as described in this disclosure. In the example shown in FIG. 7, it is assumed that the device presence data is being requested by the application server 16. However, as shown in dashed lines in FIG. 7, it can be appreciated that the request for device presence data may also originate from the application 18 on the mobile device 12. It can also be appreciated that the presence data being requested by the application server 16 may relate to a plurality of mobile devices 12 and presence information requested by one mobile device 12 may relate to other mobile devices (not shown) running the application 18.

In the example shown in FIG. 7, the application server 16 uses the device presence API 22 to send an application inquiry 36 to the device presence proxy 20 at 58, either directly or via the cloud gateway 26. As noted above, the application inquiry 36 may originate at the application server 16, or may be facilitated by or forwarded on behalf of the mobile device 12. As shown in dashed lines, the application 18 on the mobile device 12 may send a presence request to the application server 16 at 54, which is received by the application server 16 at 56. It can also be appreciated that the presence request may also be sent by the mobile device 12 directly to the device presence proxy 20 in other examples.

The device presence proxy 20 receives the application inquiry 36 at 60 and obtains network data at 62 based on a request-response mechanism employed in communicating with one or more components or nodes within the network infrastructure 14. The network data is provided by the network infrastructure 14 at 64 and this data may be mined or otherwise found or determined by the network infrastructure 14 at 66 depending on the nature of the application inquiry 36, etc. For example, the device presence proxy 20 may determine a type of presence data from the application inquiry 36 and generate a network data request 38 that can be sent directly to a particular node in the network infrastructure 14. In other examples, more complicated request-response mechanisms may be employed in order to obtain the network data response 40 required to generate the application inquiry response 42. One such example is described below.

The device presence proxy 20 determines a response to the application inquiry 36 at 68 based on the nature of the data exposed by the network infrastructure 14 and sends an inquiry response 42 to the application server 16 directly or via the cloud gateway 26 at 70. The application server 16 receives the inquiry response 42 at 72 and utilizes the presence data at 74, e.g., to update a presence database or to perform a server-based operation such as updating a presence server (not shown). It can be appreciated that, as shown in dashed lines, the application server 16 may also provide presence data to the application 18 at 76, which is received by the mobile device 12 at 78.

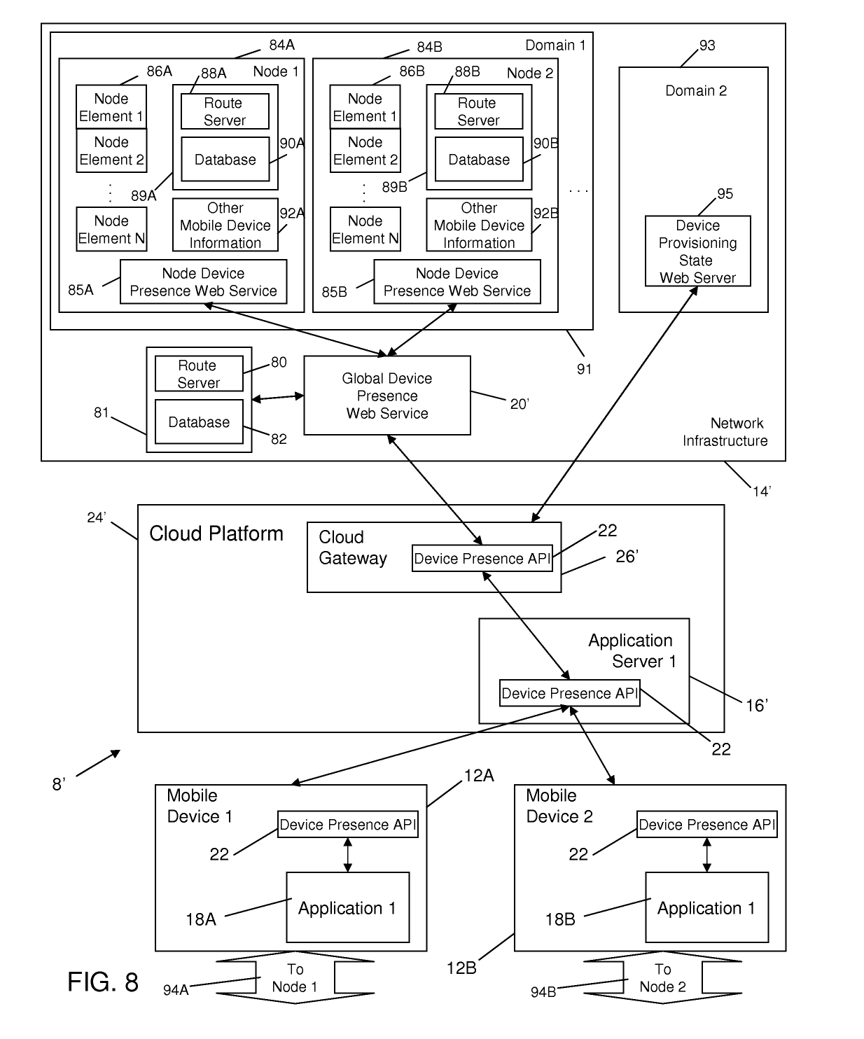

Referring now to FIG. 8, an example of a particular network infrastructure 14′ is shown. In this example, an application 18A of a first mobile device 12A places a request for device presence information to an associated application server 16′. In another alternative (not shown), the application 18A may place the request for device presence information directly to the device presence proxy 20. The requested device presence information may pertain to the presence information of the first mobile device 12A, a second mobile device 12B, or any other mobile devices (not shown) having an application client 18. The application client 18A of the first mobile device 12A identifies the mobile device 12 (e.g. second mobile device 12B) for which the presence information is being requested by providing identifying information corresponding to that mobile device. For example, a personal identification number (PIN) associated with that mobile device 12 may be provided by the first mobile device 12A. The PIN may be a sequence of alphanumeric characters uniquely identifying a mobile device. The request for device presence data, which includes the supplied PIN, is received by the application server 16 and passed to the cloud gateway 26′ for authorization and routing, using the device presence API 22 in the application server 16′. Assuming the request is authorized, the cloud gateway 26′ routes the request to the device presence proxy 20, which in this example includes a global device presence web service 20′ in the network infrastructure 14′, and node device presence web services 85 in respective nodes 84 of a first domain (Domain 1) 91 in the network infrastructure 14′, e.g., a relay domain. As shown in FIG. 8, the cloud gateway 26′ may also be configured to route other requests or otherwise communicate with other domains within the network infrastructure 14′, e.g., a second domain (Domain 2) 93 having a device provisioning state web server 95 for providing device billing information for a particular mobile device 12.

The global device presence web service 20′ identifies, from a plurality of infrastructure nodes 84, the node containing presence information of the mobile device 12 for which the presence information is being requested. For example, the first mobile device 12A may receive network service(s) 94A provided by a first infrastructure node 84A. Hence, the global device presence web service 20′ identifies the first infrastructure node 84A to retrieve presence information relevant to the first mobile device 12A. In another example, the application client 18A of the first mobile device 12A may want to determine presence information of the second mobile device 12B. The second mobile device 12B in this example receives network service(s) 94B provided by a second infrastructure node 84B. Hence, the global device presence web service 20′ identifies the second infrastructure node 84B to retrieve presence information relevant to the second mobile device 12B.

To identify the infrastructure node 84 containing presence information relevant to the mobile device 12 for which the presence information is being requested, the global device presence web service 20′ may access a route service 80 or a relay database 82 in a storage element 81. The route service 80 and the relay database 82 are complementary services which both provide PIN routing information that can used to match the supplied PIN to a corresponding node ID. The node ID identifies the infrastructure node 84 which can handle discovery of the relevant presence information. For example, the node ID may identify one of a plurality of infrastructure node elements 86 in the corresponding infrastructure node 84. Current routing information from the relay database 82 may also be included in the route service 80. If the route service 80 is not available, the relay database 82 can be used to look up the current node ID of the PIN.

FIG. 8 illustrates further detail of the first infrastructure node 84A and the second infrastructure node 84B. The first infrastructure node 84A includes one or more node elements 86A which handle requests for device presence information. The node elements 86A may include, among other things, a server or other network infrastructure element. The first infrastructure node 84A also includes a route service 88A and a relay database 90A in a storage element 89A, and various other mobile device information sources 92A, e.g., a wireless transport. The first infrastructure node 84A also includes a node device presence web service 85A for receiving and processing requests from the global device presence web service 20′ It can be appreciated that the second infrastructure node 84B includes similar components identified using the suffix “B”.

Once the node device presence web service 85 identifies the node element 86 to which the request will be sent, the node device presence web service 85 proxies the request to the identified node element 86. If the request to the node element 86 times out, the request is resubmitted to another node element 86 within the same infrastructure node 84. Upon receiving the request from the node device presence web service 85, the node element 86 may, for example, identify a wireless transport handling the mobile device 12, and query that wireless transport for the presence data. The node element 86 may alternatively mine data from the local route service 88 and the local relay database 90 to extract presence information.

The cloud gateway 26′ shown in FIG. 8 may communicate with the global device presence web service 20′ using a Simple Object Access Protocol (SOAP). The global device presence web service 20′ may also communicate with the plurality of infrastructure nodes 84 using SOAP. The infrastructure node elements 86 may communicate with the local wireless transports through an Inter Relay Protocol (IRP) communication. Communication between the global device presence web service 20′ and the route server 80 may be handled through IRP communications. The relay database 82 may be, for example, an SQL database. It should be understood that other common protocols may be used for communications between the global presence web service 20′ and the cloud gateway 26′, between the global presence web service 20′ and the infrastructure node elements 86, or between the global presence web service 20′ and the route server 80.

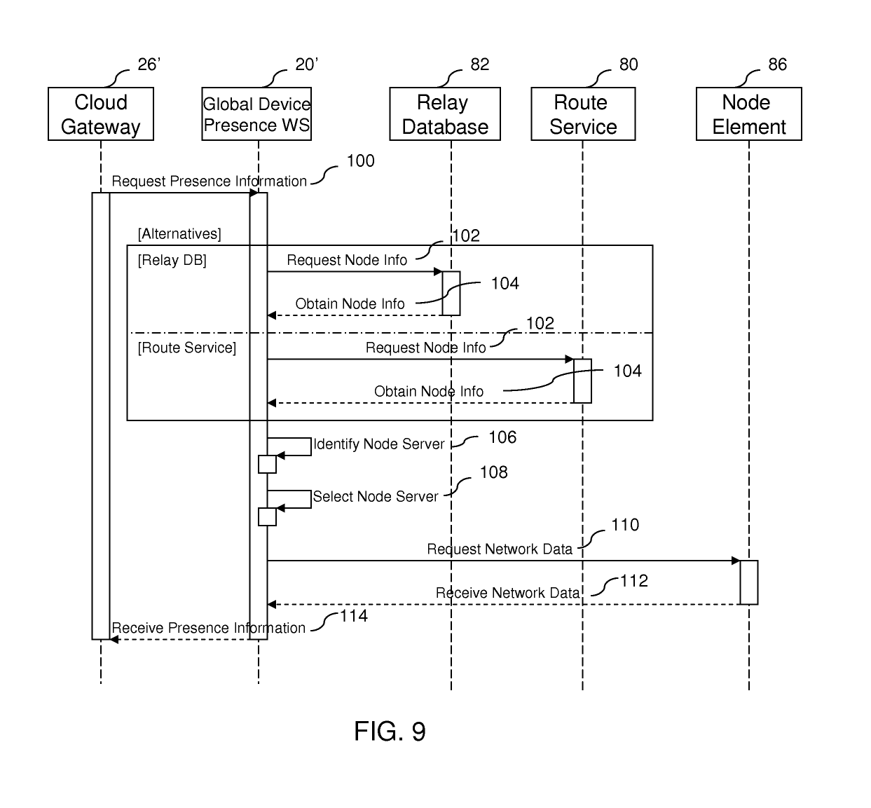

Referring now to FIG. 9, a sequence diagram is provided illustrating a process by which the cloud gateway 26′ may forward a request for presence information for a mobile device 12 on behalf of an application server 16. In the example shown in FIG. 9, the cloud gateway 26′ places a request for presence information at 100 to the global device presence web service 20′. In the request made at 100, the cloud gateway 26′ provides a PIN corresponding to the mobile device 12 for which the presence information is being requested. The global device presence web service 20′ then places a request to the relay database 82 or route server 80 at 102, to determine PIN routing information. The PIN routing information is obtained by the global device presence web service 20′ at 104. Based on the obtained routing information, the global device presence web service 20′ identifies the node element 86 corresponding to the one or more identified node IDs at 106, and selects the node element 86 at 108. Once the appropriate node element 86 has been identified, the global device presence web service 20′ may then send a request for network data to the node element 86 at 110 via the respective node device presence web service 85. The global device presence web service 20′ receives the presence information from the node element 86 at 112. The global device presence web service 20′ may then return the presence information to the cloud gateway 26′ at 114, which may be passed back to the application server 16′ or application 18.

By having access to both the route service 80 and relay database 82, the global device presence web service 20′ is provided with the flexibility of having alternative sources of information to identify the infrastructure node 84 corresponding to the mobile device 12 associated with the presence information request. Similarly, the infrastructure nodes 84 having access to both local route services 88 and local relay databases 90, are provided with the flexibility of having alternative sources of information to identify the appropriate mobile device information sources, such as a wireless transport, for determining the appropriate network data.

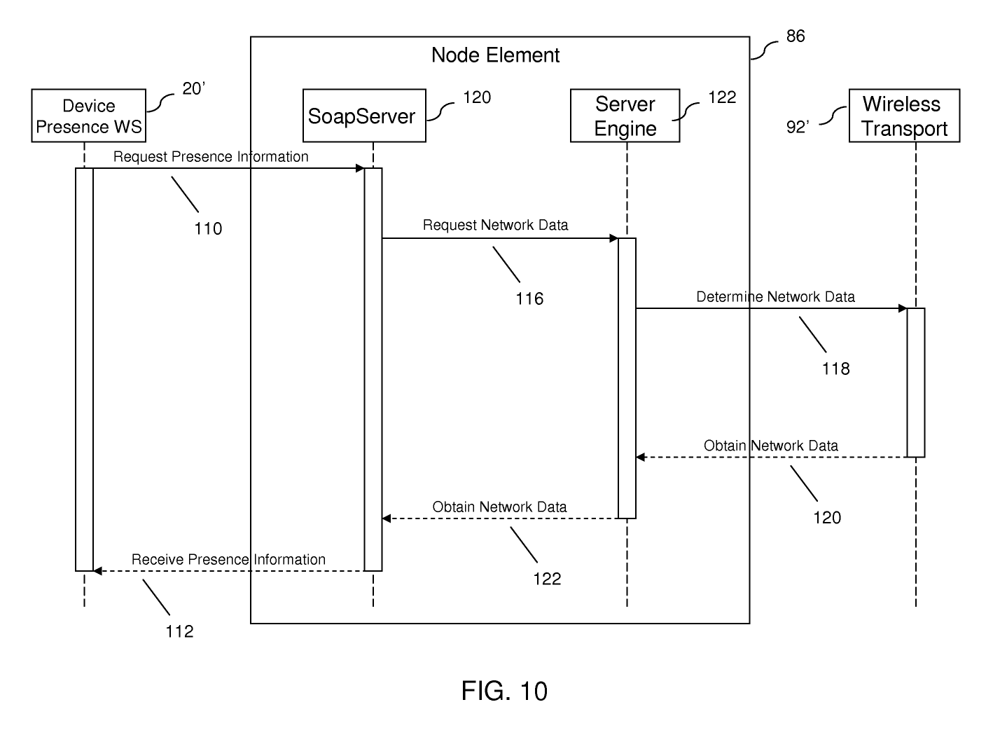

Referring now to FIG. 10, a sequence diagram is provided illustrating one way in which the node element 86 may handle the request provided by the global device presence web service 20′ to the node device presence web service 85 at 110. The request sent at 110 may be translated by a SOAP server 120 in the node element 86 from a request for presence information to a request for network data at 116. The request for network data sent at 116 is then processed by a server engine 122. The server engine 120 determines the network data relevant to the presence information at 118 by mining the appropriate wireless transport 92′. The network data is obtained by the server engine 122 at 120, and then obtained by the SOAP server 120 at 122. At this point, the network data may be converted back into presence information. This presence information is then sent to the global device presence web service 20′ at 112 as shown in FIG. 9.

It can be appreciated that various types of presence information can be mined from the network infrastructure 14 using the principles discussed herein.

For example, transport type and coverage status of a mobile device 12 can be identified. The mobile device transport type can, for example, be cellular or WiFi. The coverage status can, for example, be “in coverage,” “out of coverage,” or “having uncertain coverage.” Transport type and coverage status can be mined from the wireless transport 92′. Using the methods described above, transport type and coverage status of a mobile device 12 can be identified by having the global device presence web service 20′ select an appropriate node element 86, issue a “GetPinCoverage” SOAP request to the identified node element 86, and wait for a response. The SOAP request issued by the global device presence web service 20′ may include the request entity, request ID and mobile device PIN as inputs. The node element 86 identifies the appropriate wireless transport 92′ where the coverage status and transport type can be found, and extracts the relevant information. The response from the node element 86 may include a request/response header which include the request entity, request ID, mobile device PIN and result status code; the coverage state (in, our, or uncertain), a coverage timestamp indicating the time of last coverage state change) and a transport type (cellular or WiFi).

Roaming status of a mobile device 12 can also be identified. The mobile device 12 may be roaming, not roaming, or of an unknown roaming status. Roaming status can be mined from the local relay database 90 of the infrastructure node 84 being queried. Using the methods described above, roaming status of a mobile device 12 can be identified by having the global device presence web service 20′ or node device presence web service 85 select an appropriate node element 86, issue a “GetPinRoaming” SOAP request to the identified node element 86, and wait for a response. The SOAP request issued by the global device presence web service 20′ may include the request entity, request ID and mobile device PIN as inputs. The node element 86 queries, e.g., the local relay database 90 for the roaming status of the mobile device 12. The response from the node element 86 may include a request/response header which include the request entity, request ID, mobile device PIN and result status code; and the roaming status (roaming, not roaming, or unknown).

Accordingly, there is provided a method comprising: receiving, via an application programming interface, an application inquiry, the application inquiry requesting a presence data for at least one mobile device; responsive to receiving said inquiry, obtaining network data from one or more network infrastructure nodes associated with providing service to the at least one mobile device; determining a response to the application inquiry based upon the network data; and providing the response via the application programming interface.

There is also provided a device presence proxy apparatus comprising a processor and a memory, the memory comprising computer executable instructions for: receiving, via an application programming interface, an application inquiry, the application inquiry requesting a presence data for at least one mobile device; responsive to receiving said inquiry, obtaining network data from one or more network infrastructure nodes associated with providing service to the at least one mobile device; determining a response to the application inquiry based upon the network data; and providing the response via the application programming interface.

There is also provided a computer readable medium comprising computer executable instructions for: receiving, via an application programming interface, an application inquiry, the application inquiry requesting a presence data for at least one mobile device; responsive to receiving said inquiry, obtaining network data from one or more network infrastructure nodes associated with providing service to the at least one mobile device; determining a response to the application inquiry based upon the network data; and providing the response via the application programming interface.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device presence proxy 20, application server 16, cloud platform 24, cloud gateway 26, or mobile device 12, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method comprising:
receiving, via an application programming interface, an application inquiry, the application inquiry requesting a presence data for at least one mobile device;
responsive to receiving said inquiry, obtaining network data from one or more network infrastructure nodes associated with providing service to the at least one mobile device;
determining a response to the application inquiry based upon the network data; and
providing the response via the application programming interface.

2. The method of claim 1, further comprising:
selectively providing the application programming interface to a server or an application, or both the server and the application, based upon a subscription by a particular mobile device.

3. The method of claim 2, wherein the subscription is associated with an application loaded on the particular mobile device.

4. The method of claim 1, the presence data includes any one or more of:
coverage status,
roaming status,
transport type,
date of a previous transport change,
time of a previous transport change,
last authentication result for the mobile device, and
last time of authentication.

5. The method of claim 1, wherein the response is based upon network data obtained from a plurality of network infrastructure nodes.

6. The method of claim 1, the application programming interface associated with a cloud application development platform.

7. The method of claim 1, wherein obtaining said network data includes communicating with a first network infrastructure node to identify a second network infrastructure node that is capable of providing said network data.

8. The method of claim 1, the application inquiry including an identifier associated with the said at least one mobile device.

9. The method of claim 8, wherein the identifier is used to determine said one or more network infrastructure nodes from which to obtain said network data.

10. The method of claim 1, wherein said obtaining includes:
communicating a network inquiry to said one or more network infrastructure nodes; and
receiving one or more network responses from said one or more network infrastructure nodes, the one or more network responses including the network data.

11. The method of claim 1, wherein the application inquiry requests presence data for a plurality of mobile devices, and the response includes a presence status for each of the plurality of mobile devices.

12. A device presence proxy apparatus comprising a processor and a memory, the memory comprising computer executable instructions for:
receiving, via an application programming interface, an application inquiry, the application inquiry requesting a presence data for at least one mobile device;
responsive to receiving said inquiry, obtaining network data from one or more network infrastructure nodes associated with providing service to the at least one mobile device;
determining a response to the application inquiry based upon the network data; and
providing the response via the application programming interface.

13. The device presence proxy apparatus of claim 12, further comprising instructions for:
selectively providing the application programming interface to a server or an application, or both the server and the application, based upon a subscription by a particular mobile device.

14. The device presence proxy apparatus of claim 13, wherein the subscription is associated with an application loaded on the particular mobile device.

15. The device presence proxy apparatus of claim 12, the presence data includes any one or more of:
coverage status,
roaming status,
transport type,
date of a previous transport change,
time of a previous transport change,
last authentication result for the mobile device, and
last time of authentication.

16. The device presence proxy apparatus of claim 12, wherein the response is based upon network data obtained from a plurality of network infrastructure nodes.

17. The device presence proxy apparatus of claim 12, the application programming interface associated with a cloud application development platform.

18. The device presence proxy apparatus of claim 12, wherein obtaining said network data includes communicating with a first network infrastructure node to identify a second network infrastructure node that is capable of providing said network data.

19. The device presence proxy apparatus of claim 12, the application inquiry including an identifier associated with the said at least one mobile device.

20. The device presence proxy apparatus of claim 19, wherein the identifier is used to determine said one or more network infrastructure nodes from which to obtain said network data.

21. The device presence proxy apparatus of claim 12, wherein the obtaining includes:
communicating a network inquiry to said one or more network infrastructure nodes; and
receiving one or more network responses from said one or more network infrastructure nodes, the one or more network responses including the network data.

22. The device presence proxy apparatus of claim 12, wherein the application inquiry requests presence data for a plurality of mobile devices, and the response includes a presence status for each of the plurality of mobile devices.

23. A computer readable medium comprising computer executable instructions for:
receiving, via an application programming interface, an application inquiry, the application inquiry requesting a presence data for at least one mobile device;
responsive to receiving said inquiry, obtaining network data from one or more network infrastructure nodes associated with providing service to the at least one mobile device;
determining a response to the application inquiry based upon the network data; and
providing the response via the application programming interface.

24. The computer readable medium of claim 23, further comprising instructions for:
selectively providing the application programming interface to a server or an application, or both the server and the application, based upon a subscription by a particular mobile device.

25. The computer readable medium of claim 24, wherein the subscription is associated with an application loaded on the particular mobile device.

26. The computer readable medium of claim 23, the presence data includes any one or more of:
coverage status,
roaming status,
transport type,
date of a previous transport change,
time of a previous transport change,
last authentication result for the mobile device, and
last time of authentication.

27. The computer readable medium of claim 23, wherein the response is based upon network data obtained from a plurality of network infrastructure nodes.

28. The computer readable medium of claim 23, the application programming interface associated with a cloud application development platform.

29. The computer readable medium of claim 23, wherein obtaining said network data includes communicating with a first network infrastructure node to identify a second network infrastructure node that is capable of providing said network data.

30. The computer readable medium of claim 23, the application inquiry including an identifier associated with the said at least one mobile device.

31. The computer readable medium of claim 30, wherein the identifier is used to determine said one or more network infrastructure nodes from which to obtain said network data.

32. The computer readable medium of claim 23, wherein the obtaining includes:
communicating a network inquiry to said one or more network infrastructure nodes; and
receiving one or more network responses from said one or more network infrastructure nodes, the one or more network responses including the network data.

33. The computer readable medium of claim 23, wherein the application inquiry requests presence data for a plurality of mobile devices, and the response includes a presence status for each of the plurality of mobile devices.
